(19) United States
(12) Patent Application Publication
(10) Pub. No.: US 2026/0254857 A1
(43) Pub. Date: Aug. 27, 2026

(54) SYSTEMS AND METHODS FOR CROSS-HOST ATTACK PREVENTION USING PROGRAMMABLE DATA PLANES

(71) Applicant: VIRGINIA TECH INTELLECTUAL PROPERTIES, INC., Blacksburg, VA (US)

(72) Inventors: Osama Bajaber, Blacksburg, VA (US); Bo Ji, Blacksburg, VA (US); Peng Gao, Blacksburg, VA (US)

(21) Appl. No.: 19/546,882

(22) Filed: Feb. 23, 2026

Related U.S. Application Data
(60) Provisional application No. 63/761,312, filed on Feb. 21, 2025.

(51) Int. Cl. H04L 9/40

(52) U.S. Cl. CPC H04L 63/20

(57) ABSTRACT

An example network security system includes one or more memories storing processor-readable instructions, and one or more processors configured to access the one or more memories and execute the processor-readable instructions to perform operations. The operations include receiving a network flow associated with communication between a plurality of hosts, obtaining a security label associated with the network flow, matching the security label or a flow attribute of the network flow against a plurality of security policies, and executing a security action on the network flow based on the matching to restrict unauthorized inter-host information flow among the plurality of hosts.

### CROSS-REFERENCE TO RELATED APPLICATIONS

This application claims the benefit of and priority to U.S. Provisional Patent Application No. 63/761,312, filed Feb. 21, 2025, the entire contents of which is hereby incorporated herein by reference.

### BACKGROUND

Despite advancements in operational network security, there are still rapid increases in targeted cyber-attacks such as Advanced Persistent Threats (APTs), among others. These sophisticated attacks often exploit multiple hosts in a network and laterally move targets to access unauthorized resources or exfiltrate sensitive data, which may result in large losses for many businesses. Additionally, cross-host attacks pose significant challenges to existing defenses, which may lack necessary context to correlate attack activities on different hosts and prevent attacks from damaging corresponding networks in real time.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 depicts a schematic diagram of an example network security system according to various embodiments of the present disclosure.

FIG. 2 depicts a schematic diagram of an example implementation of the network security system shown in FIG. 1 according to various embodiments of the present disclosure.

FIG. 3 depicts a switch architecture of a programmable network device as shown in FIGS. 1 and 2 according to various embodiments of the present disclosure.

FIG. 4 depicts an example host system incorporating a defense workflow against an attacker according to various embodiments of the present disclosure.

FIG. 5 depicts a customized network packet format according to various embodiments of the present disclosure.

FIG. 6 depicts an in-network packet processing workflow implementable in the network security systems shown in FIGS. 1 and 2 according to various embodiments of the present disclosure.

FIG. 7 depicts extended Berkeley Packet Filter (eBPF) hooks and intra-host label propagation paths implementable in the network security systems shown in FIGS. 1 and 2 according to various embodiments of the present disclosure.

FIG. 8 depicts an example host system incorporating a defense workflow for preventing data exfiltration according to various embodiments of the present disclosure.

FIG. 9 depicts an example host system incorporating a defense workflow for preventing unauthorized access while endorsing high-integrity users for access according to various embodiments of the present disclosure.

FIG. 10 depicts an example host system incorporating a defense workflow for fine-grained tracking of sensitive information, according to various embodiments of the present disclosure.

FIG. 11 depicts an example method for cross-host attack prevention according to various embodiments of the present disclosure.

### DETAILED DESCRIPTION

Modern targeted attacks such as Advanced Persistent Threats (APTs) use multiple hosts as stepping stones and move laterally across them to gain deeper access to a network. However, existing defenses lack end-to-end information flow visibility across hosts and cannot block cross-host attack traffic in real time. Despite the dramatic growth in expenses on operation security, there has been a rapid increase in targeted cyber-attacks such as APTs. These sophisticated attacks often exploit multiple hosts in a network and laterally move to the target to access unauthorized resources or exfiltrate sensitive data. As a result, many high-profile businesses have been plagued with huge losses. These cross-host attacks pose significant challenges to existing defenses, which lack the necessary context to correlate attack activities on different hosts and prevent attacks from damaging the network in real time.

Existing defenses treat inter-host information flows and intra-host information flows in isolation. Hence, these defenses lack end-to-end information flow visibility across multiple hosts in a network. Network-level defenses, such as firewalls and network intrusion detection systems (NIDSes), have visibility into inter-host information flows between two hosts in the form of network flows (i.e., a sequence of packets sent from a source to a destination). However, these defenses are unable to connect network flows to reveal cross-host attack activities due to lack of host-level visibility on intermediate hosts.

On the other hand, host-level defenses capture intra-host information flows only. Many studies along this line employ system call monitoring to track information flows between system entities (e.g., processes, files) within a host for forensic investigation. However, they are unable to track attack activities beyond a single host due to inadequate network-level visibility. Although a few studies along this line proposed to associate system calls across hosts, these solutions mostly operate in post-compromise settings using historical system audit logs. In summary, none of the existing defenses are able to block cross-host attack traffic in real time when the connection is established on the fly.

To this end, various embodiments described herein include network defense systems that (1) enable end-to-end information flow visibility across hosts and (2) leverage such visibility to enforce security decisions in real time to prevent cross-host attacks. Some challenges that may need to be overcome for implementation of the above-mentioned features are as follows. To enable end-to-end visibility, an effective defense may accurately correlate information flows both within and between hosts in a cross-host attack. Furthermore, the defense system may also precisely confine the information flow among entities (e.g., hosts, packets, processes, and files) and enforce authorized accesses. While decentralized information flow control (DIFC) can provide the needed fine-grained control of information flow, existing DIFC systems have only focused on operating systems (OSes), distributed systems, and cloud computing. No existing DIFC system has enforced DIFC at the network level. Further, enforcing DIFC at the network level is highly challenging due to the huge volume of traffic in enterprise networks.

An effective defense system may be able to correlate information flows and enforce DIFC policies on the fly, without imposing significant overhead on the network performance. The defense system may be seamlessly integrated with the existing network infrastructure and may not affect the line-rate processing of large amounts of benign traffic. Third, human analysts with domain knowledge are crucial for defenses. An effective defense may hide the complexity of low-level DIFC enforcement and allow the network administrator to tailor the defenses for different attacks, through a flexible and expressive policy interface.

In the context outlined above, a network security or defense system according to the embodiments confines end-to-end information or network flows in a network and prevents cross-host attacks in real time at line rates when connection is established on the fly. The network security system implements an in-network DIFC mechanism for precise information confinement and line-rate DIFC policy enforcement. This DIFC mechanism includes a secure network-level DIFC model with a category system and an in-network DIFC enforcement approach enabled by programmable network devices (e.g., programmable switches) and extended eBPF (extended Berkeley Packet Filter). The network security system also provides a flexible and expressive policy framework to specify a wide range of DIFC policies.

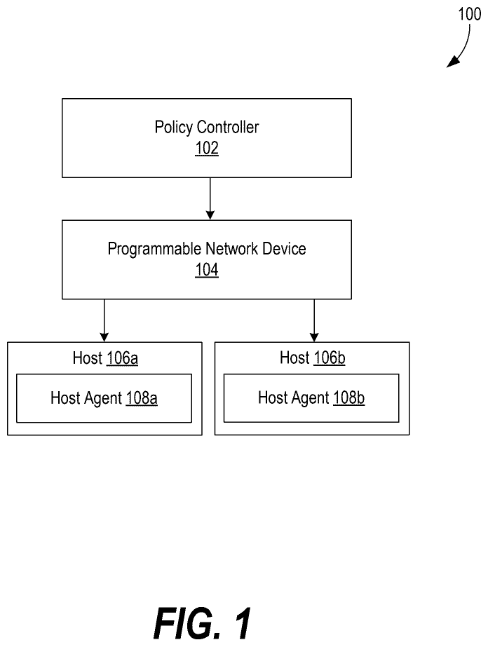

Referring now to the drawings, FIG. 1 depicts a schematic diagram of an example network security system 100 according to various embodiments. The network security system 100 includes a policy controller 102, a programmable network device 104, a host 106a and a host agent 108a executed in the host 106a, and a host 106b and a host agent 108b executed in the host 106b. The hosts 106a and 106b are referred to herein collectively as hosts 106, and the host agents 108a and 108b are referred to herein collectively as host agents 108. The number of hosts 106 and host agents 108 are shown for representative purposes only, and the number of hosts 106 and host agents 108 can vary depending on the implementation. The network security system 100 is not exhaustively illustrated, meaning that one or more components not shown can be relied upon in some cases. Alternatively, one or more components shown in FIG. 1 may be omitted in practice.

The policy controller 102 is representative of one or more policy controllers 102 and can be provided in a control-plane environment to define, manage, and distribute security policies to one or more programmable network devices (e.g., the programmable network device 104). The policy controller 102 may include a centralized or distributed computing system configured to receive high-level security policy definitions (e.g., from a network administrator) and compile the policy definitions into enforcement rules installable within the programmable network device 104. The policy controller 102 may further determine placement of policies across multiple devices and dynamically update the installed policies without interrupting active network flows. The policy controller 102 can be implemented as a software-defined networking (SDN) controller, a network management server, a security orchestration system, or another control-plane entity.

The programmable network device 104 is representative of one or more programmable data plane or network devices that may be distributed over a network. The programmable network device 104 can be provided in a programmable data plane environment and can include programmable switches (e.g., Intel® Tofino™), smart network interface cards (smartNICs), virtual switches, programmable routers, network interface devices with programmable forwarding logic, and other programmable network devices. The programmable network device 104 can be configured to enforce security policies on network flows exchanged between hosts (e.g., the hosts 106a and 106b). The programmable network device 104 can include forwarding pipelines, match-action tables, flow-state storage, and logic configured to modify metadata associated with network flows in response to policy matches. The programmable network device 104 can include data plane memory such as static random access memory (SRAM), ternary content addressable memory (TCAM), register arrays, flow-state tables, counter memory, and other types of on-chip memory. In some embodiments, the programmable network device 104 can include off-chip memory such as dynamic random access memory (DRAM), external SRAM, flash storage, persistent memory, and other types of off-chip memory.

The programmable network device 104 can include one or more processors to execute instructions or perform hardware-based forwarding operations. In some embodiments, the one or more processors may include forwarding pipeline logic, match-action processing units, packet parsing engines, and action execution circuitry configured to process network flows at line rate. In some embodiments, the processors can include general-purpose processing units, embedded control processors, or network processing units configured to install security policies and manage enforcement behavior to restrict unauthorized inter-host information flow among the hosts 106.

The hosts 106 can include physical servers, virtual machines, containers, workstations, client devices, cloud compute instances, and edge computing devices, among others. The host agents 108 can include kernel modules, eBPF programs, user-space daemons, security monitoring agents, and provenance tracking modules, among others. In various embodiments, the hosts 106 can execute the host agents 108 to track intra-host information propagation. The host agents 108 can monitor process-to-process, process-to-file, or inter-process communications within the hosts 106 and associate security labels with outbound network flows based on accumulated security tags. The host agents 108 may be implemented as kernel modules, user-space daemons, eBPF programs, or other software components configured to monitor and annotate information flows.

The policy controller 102, the programmable network device 104, the hosts 106, and the host agents 108 can be interconnected by one or more communication networks configured to enable data exchange and policy distribution among system components. For example, the communication network can include local area network (LAN), wide area network (WAN), metropolitan area network (MAN), data center fabric, cloud network infrastructure, virtual overlay network, public or private internet protocol (IP) networks, and hybrid cloud interconnects, among others. In certain embodiments, the communication network may include both physical network infrastructure and logical overlay networks implemented using tunneling, virtualization, or software-defined networking techniques.

The network security system 100 can create DIFC labels for network entities (e.g., hosts and packets) and system entities (e.g., processes and files) and propagate these labels along intra-host and inter-host flows between the entities. These labels can encode different categories, secrecy and integrity levels, etc. The network security system 100 can enforce DIFC policies specified by the network administrator on labeled flows in the network data plane at line rate. The network security system 100 can provide (1) safe mechanisms to declassify secret data to authorized readers or endorse data as high integrity and provide (2) a tainting mechanism for fine-grained tracking of the propagation path of a sensitive file in the network to limit its reachability. The network-level DIFC model implemented in the network security system 100 can formalize these operations.

The network security system 100 can leverage emerging programmable switches and eBPF to realize DIFC models in a data plane. Programmable switches offer data-plane programmability through P4 and can guarantee customized terabit per second (Tbps) line-rate packet processing. The network security system 100 can process labeled network traffic and enforce line-rate DIFC policies. To address the key challenge of limited switch memory and minimization of network overhead, the network security system 100 can employ in-network DIFC enforcement approaches with tailored techniques to label network traffic, match DIFC policies, enforce per-flow decisions, and enable declassification/endorsement controls.

To propagate DIFC labels within each host and from/to the network, lightweight host agents (e.g., host agents 108) can be implemented based on eBPF technology. The host agent is lightweight and readily deployable without any kernel modifications. These host agents are different and improved from previous DIFC works, which require extensive OS kernel modifications to track intra-host information flows. The host agent enables lightweight DIFC label persistence by attaching carefully defined eBPF hooks in the kernel to capture the complete chain of intra-host system events and accurately propagate DIFC labels, with minimal overhead on the host machine.

While programmable switches can enable in-network DIFC, there may be challenges for network administrators to directly program the data plane using P4, which is low-level and can be error-prone. To unlock the powerful in-network DIFC context, the network security system 100 can integrate an expressive domain-specific language Network Control Language (referred to herein as “NETCL”), which is an expressive domain-specific language that enables the network administrator to specify DIFC policies that match cross-host flows and trigger a wide range of defense actions, including preventing data exfiltration, detecting unauthorized access, declassifying information, and limiting the reachability of sensitive files and the spread of malware. NETCL policies (e.g., security policies) follow a priority-based enforcement similar to the traditional firewall policies. To further enhance the defense agility against an attacker's possibly changing strategies, the network security system 100 employs an efficient compilation mechanism that supports dynamical update of NETCL policies at runtime without interrupting network traffic.

The network security system 100 can enforce DIFC at the network level at line rate where existing approaches cannot. The network security system 100 can use programmable data planes to enforce complex secrecy and integrity policies at line rate, where existing approaches cannot. The network security system 100 can provide network-level APT defenses using programmable data planes, which differ from existing system-level APT defenses based on system audit logs and system provenance graphs.

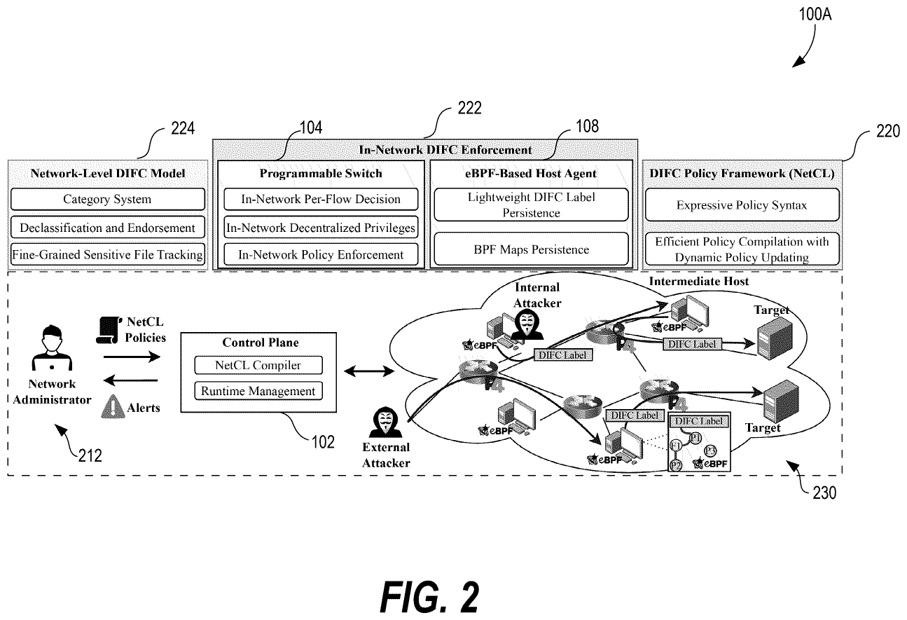

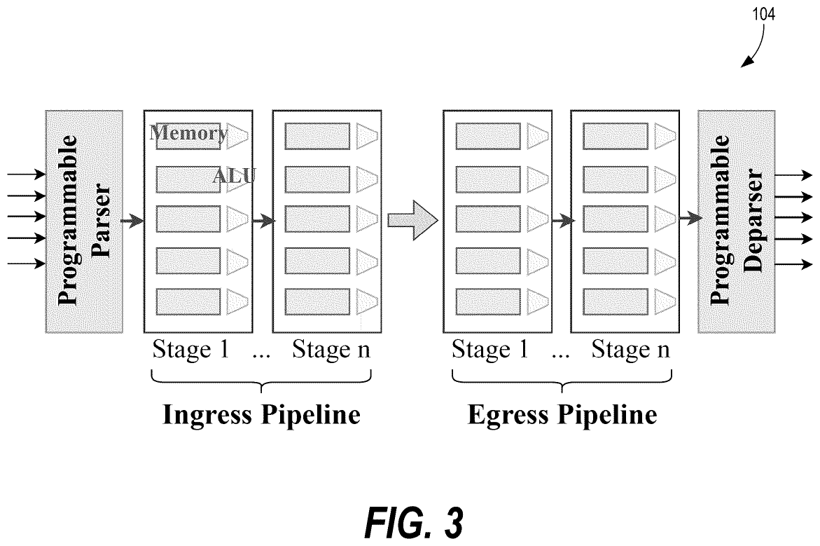

FIG. 2 depicts a schematic diagram of an example implementation 100A of the network security system 100, and FIG. 3 depicts a switch architecture of the programmable network device 104 according to various embodiments. The implementation 100A (also referred to herein as “network security system 100A”) can include additional blocks not explicitly shown in FIG. 1, such as a DIFC policy framework block 220 and a network-level DIFC model block 224. The network security system 100A is an implementation of the network security system 100 and can include all elements and features described with respect to the network security system 100 and may further include additional components or modifications as described herein. The network security system 100A represents one example configuration of the network security system 100. Features described with respect to the network security system 100A can be incorporated into various embodiments or configurations of the network security system 100 unless otherwise indicated.

The network security system 100A includes an in-network DIFC enforcement block 222, which can include programmable switches (e.g., such as the programmable network device 104) and eBPF-based host agents (e.g., such as the host agents 108). The network security system 100A includes a network administrator 212 who can define NETCL or security policies. The policy controller 102 can include a control plane that can receive the defined policies and compile the policies for security label propagation to various hosts shown in an example host system 230.

Referring to FIG. 3, for the programmable network device 104, P4 programs can specify packet headers and operations on the packet headers. A programmable parser can parse user-defined packet headers, and these headers can go through multiple hardware stages with arithmetic logic units (ALUs) and match/action tables, where match fields and types (e.g., exact/range/ternary matching) can be specified. These stages can use SRAM and TCAM for match lookups. While SRAM supports exact matching and persists data across packets for stateful processing, TCAM can support wildcard matches over header fields. Unfortunately, switching application-specific integrated circuits (ASICs) offer only limited memory (e.g., hundreds of MB of SRAM and tens of MB of TCAM). To enforce line-rate processing, P4 programs may limit the operations in each stage. A programmable deparser can reassemble a packet before the packet leaves the programmable network device 104 and gets forwarded.

Information flow control (IFC) monitors and regulates the movement of information within a system. In classical centralized IFC, a central authority assigns predefined security labels to subjects (e.g., processes) and objects (e.g., files) and enforces IFC policies. Only the central authority can change labels or policies in these systems. DIFC is a generalization of the classical IFC and offers more flexibility and autonomy. In DIFC, data owners can set their own security policies and labels for their data, and grant permissions to subjects to alter their labels. While prior works have integrated DIFC with OS and extended the works to Android and distributed systems, these implementations require substantial modifications to the kernel or user-space application, which can be highly complex. Besides, the enforcement for these systems happens within individual hosts rather than in the network. These DIFC systems also incur a significant overhead on system operations due to the low processing power of host systems and fail to meet line-rate requirements. While other works have employed IFC in cloud environments, these works focus on the interactions between users and cloud providers, which are distinct from network communications.

Referring back to FIG. 2, the network security system 100A is first initialized. For example, the network administrator 212 can specify NETCL policies for assigning security labels or DIFC labels (e.g., a set of DIFC tags) to hosts and matching network flows. Next, the programmable network device 104 can send a control packet containing the specified DIFC label to a corresponding host agent such as the host agent 108a or 108b. Next, the host agent 108a or 108b initializes existing processes and files in the host 106a or 106b with the received DIFC label.

The network security system 100A can incorporate DIFC context persistence. As an attacker enters the host system 230, the host agent 108a, for example, can propagate the DIFC label between system entities along with the attacker's activities. When the attacker pivots to another host, the host agent 108a propagates the DIFC label to the network by incorporating the DIFC label into the outgoing network flow (e.g., in a customized DIFC packet header). The host agent on the receiver host extracts the DIFC label from the network flow, merges it with the label of the receiver process, and continues propagating the updated label. This way, the host agents 108 maintain the DIFC context persistence across the network.

The network security system 100A can enforce DIFC policies. NETCL policies specified by the network administrator 212 can be compiled into different in-network policies, which are inserted into match/action tables of the programmable network device 104. When a labeled network flow arrives at the programmable network device 104, the programmable network device 104 extracts DIFC tags from the DIFC label and uses these tags to correlate all previous flows. The programmable network device 104 then matches these tags against the in-network policies to trigger the corresponding security action (e.g., drop the flow) at line rate.

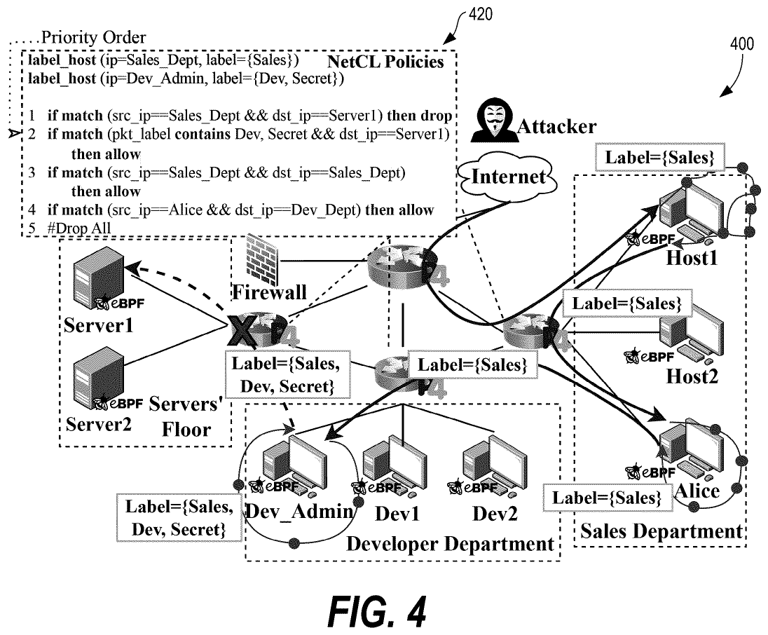

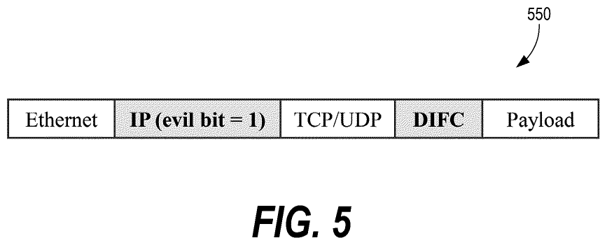

FIG. 4 depicts an example host system 400 incorporating a defense workflow against an attacker, and FIG. 5 depicts a customized network packet format 550 according to various embodiments. The defense workflow in the host system 400 can be implemented by the network security system 100 and any implementations thereof. The network security system 100 can be configured to parse DIFC labels (e.g., indicated by the term “Label”) to precisely correlate and confine information flows across hosts and block cross-host attack traffic in real time based on priority-ordered DIFC policies 420. For example, after initialization, processes on Dev_Admin have the label {Dev, Secret} with the tags Dev and Secret. When the attacker pivots from the Sales Department to Dev_Admin, the {Sales} label is propagated to the network flow, and the attacker process on Dev_Admin then has the label {Sales, Dev, Secret}, indicating that the process has previous interactions with entities that have the Sales tag. Subsequently, when the attacker tries to connect to Server1, the programmable network device 104 detects the presence of the Sales tag in the network flow and realizes that the flow traverses the Sales Department. The programmable network device 104 then enforces the matched policy that has the highest priority (i.e., the drop policy) to drop the traffic.

A threat model of the network security system 100A assumes the presence of an attacker seeking to access or modify unauthorized resources, exfiltrate confidential data, or spread malware, either from within the network or externally, by exploiting trust relationships among networked hosts. A trusted computing base can include programmable network devices (such as programmable switches), the control plane, and host agents. The network security system 100A may assume that OS kernels are secure from compromise, and that the network administrator 212 specifies policies correctly especially regarding declassification, according to some embodiments.

The network security system 100A can implement a secure network-level DIFC model with a category system to associate entities with DIFC labels, a declassification and endorsement mechanism, and a mechanism for fine-grained tracking of sensitive files. The network security system 100A incorporates a category system which associates different network entities (e.g., hosts and packets) and system entities (e.g., processes and files) with DIFC tags and DIFC labels. In example implementations, a Flume DIFC model, which is a host-level DIFC model, can be extended to the network level and security guarantees of the Flume DIFC model can be inherited. The network security system 100A can use DIFC tags to govern the flow of information between processes and files residing on the same machine and processes residing on different machines. Security tags (referred to as also “tags” herein) are assigned to both subjects (e.g., processes) and objects (e.g., files). Directories can be treated as files. A set of tags form a DIFC label. These tags and labels can encode various categories (e.g., different enterprise departments, business departments, or other customizable categories) and secrecy and integrity levels (e.g., top-secret, secret, and unclassified) for entities to achieve enhanced multi-level security, adhering to the principle of least privilege.

The following describes example expressions that can be implemented by the networks security system 100A, although other implementations of expressions are possible. For example, let Sₚ and Iₚ be the secrecy and integrity labels of entity p, respectively, and let Lₚ=Sₚ∪Iₚ be its overall label. According to Flume's safe message rules, for example, process p can send a message to process q if Sₚ⊆Sₛ (i.e., “no read up, no write down”) and Iₚ ⊇Iₛ (i.e., “no read down, no write up”). To extend the label visibility from a single host to the network, the network security system 100A incorporates the labeling of network packets. When a message m is sent from process p to process q, a label Lₘ is assigned to m. For the message m to be delivered to q, the message may satisfy the condition Lₚ⊆Lₘ⊆Lₛ before delivery.

To comply with the safe message rules (e.g., of Flume), processes may need to change their labels before they can communicate with other processes or files. For example, a process that carries a Sales tag can only share data with processes having a matching Sales tag. Note that in Flume, explicit label change requires the prediction of communication patterns of subject processes to adjust labels. However, this approach is impractical in unpredictable environments and requires significant effort to modify all applications' code, limiting the DIFC's efficacy. Therefore, the networks security system 100A adopts implicit label change, allowing implicit label propagation between processes and files. For example, if process p communicates with process q, then both of their labels merge to update Lₛ (i.e., Lₛ=Lₚ∪Lₛ) . If processes p and q are on different machines, p appends its label to the outgoing packets, which is then propagated to process q upon arrival. For files, if a process p reads from an existing file ƒ, it initiates a flow from ƒ to p, propagating ƒ's label to p. This confirms that p has accessed data tagged with Lₑ. When p writes to a new file ƒ, p specifies Lₑ for ƒ, which includes all tags in Lₚ. This design is important in tracking long-going attacks that involve data theft stored for future exfiltration.

The network security system 100A supports decentralized privileges to declassify (remove secrecy tags) or endorse (add integrity tags) information. Each tag t has two associated capabilities: t⁺ allows a process to add tag t to its label, and t⁻ allows removing tag t. For example implementations, let Cₚ be the set of capabilities that process p has. Process p can add (or remove) tag t to its label only if it has the capability t⁺∈Cₚ (or t⁻∈Cₚ). For secrecy, the capability t⁻ allows a process to declassify information associated with tag t. For integrity, the capability t⁺ allows a process to endorse its state with an integrity level associated with the tag t. As remote hosts are untrusted, they are modeled as an untrusted process x with an empty label (i.e., Lₓ={}). Therefore, to interact with the outside world, a process may need to have the capability to reduce its label to {}.

When a sensitive file is declassified, regulating the file's accessibility to unauthorized readers is difficult. To address this issue, the network security system 100A enhances implemented DIFC models with a special TrackerID tag and a tainting mechanism for specific files. If a process reads a tagged file, the process can inherits the TrackerID, which is then propagated to other processes and to the network when the file data is exported. This alerts the programmable switch that a file with the TrackerID tag is being transmitted. This design offers two significant benefits. First, TrackerID enables fine-grained tracking and policy enforcement on specific sensitive files. Second, TrackerID can be monitored to create a provenance graph, which is useful for tracking declassified sensitive files and forensic analysis.

The network security system 100A can realize network-level DIFC models in the data plane. For example, the network security system 100A can leverage eBPF to realize implicit label propagation within each host and between hosts to maintain the DIFC context persistence. the network security system 100A can leverage the programmable network device 104 to further regulate the label propagation between hosts by parsing the DIFC label carried in the network flow and enforcing line-rate DIFC policies. To minimize the network overhead, the network security system 100A employs an in-network per-flow decision mechanism that enforces DIFC policies at the flow granularity, removing the need for labeling and matching every packet in the flow. The network security system 100A also employs a multi-table flow matching technique to support a large number of in-network policies with limited switch memory.

To carry the DIFC label in network traffic, the network security system 100A can employ a customized network packet format as shown in FIG. 5. A reserved bit in the IP fragment field (known as the “evil” bit) can be set to distinguish labeled packets from regular packets. The network security system 100A can use a DIFC packet header to carry DIFC tags. These tags can be extracted by the programmable network device 104. An example implementation considers a 32-byte DIFC packet header, which supports 256 distinct tags (each bit represents a tag), although other sized packet headers and other numbers of distinct tags are also implementable. These sizes and numbers indicate the number of categories and security levels in the network that can be supported by a programmable switch. It is noteworthy that this capacity largely exceeds the U.S. Department of Defense's minimum access control requirement of 16 sensitivity classifications and 64 categories.

The network security system 100A can implement per-flow decisions. A naïve way of carrying DIFC labels would encompass labeling every packet in a network flow. However, such labeling would waste resources, as the same security decision applies to all packets in the same network flow. To reduce the network overhead, the network security system 100A employs an in-network per-flow decision mechanism using stateful registers in programmable switches according to example implementations. Rather than labeling every packet in a network flow, the network security system 100A may only add the DIFC packet header to the initial packets of a flow. The security decision for the flow is then maintained in a match/action table (called ConnDec table), which includes the flow's 5-tuple key (IP_{src}, Port_{src}, IP_{dst}, Port_{dst}, Protocol) and the decision value. Subsequent packets in the flow can match the corresponding entry in the ConnDec table, and the same decision can be applied.

The network security system 100A can employ different strategies to support different network protocols. For TCP connections, the host agents 108 can add the DIFC packet header to the SYN packet during a three-way handshake. This implementation can guarantee that the label is received by the programmable network device 104 for successful connections. However, in UDP connections, where packet delivery is not guaranteed, the programmable network device 104 may not receive the packet that carries the label. To address this, the host agents 108 can add the DIFC packet header to the first few UDP packets in a new connection. Once the programmable network device 104 receives a packet with the DIFC packet header, the programmable network device 104 can craft an ACK packet using the hardware packet generator and can send it back to the sender host. This acknowledges that the DIFC label has been received, allowing the host (e.g., host 106a or 106b) to send the remaining packets without additional DIFC packet headers. For ICMP, the host agent (e.g., host agent 108a or 108b) can add the DIFC packet header to ICMP request and reply packets.

Match/action tables can handle a large number of entries, and the control plane may need to be involved to add entries to ConnDec for every new network flow. This can mean that the programmable network device 104 has to request the control plane to install an entry after matching a new flow, introducing a delay, known as round-trip time (RTT), from when the programmable network device 104 matches a decision for a new flow to the point where the entry is inserted into ConnDec. During this time period, the remaining packets of the matched flow can arrive at the programmable network device 104 before their entry is inserted.

To address this issue, a hardware buffer structure using stateful registers can be implemented, which can be directly updated by the data plane of the programmable network device 104 at line rate. When a new network flow arrives, the programmable network device 104 matches the flow using the DIFC label in the flow's first packet, inserts an entry to the buffer on the fly, and can send a request to the control plane to update ConnDec. Each entry in the buffer stores the CRC hash value of the flow's 5-tuple key and the security decision. When the remaining data packets arrive at the programmable network device 104, the network security system 100A can calculate the hash values of the remaining data packets and match them with the buffered decision until the corresponding entry is inserted into ConnDec.

It should be noted that hash collisions can happen. If a new network flow, flow2, has a collision with an existing flow, flow1, in the buffer, the network security system 100A evicts flow1's entry to make room for flow2. However, flow1's entry might be evicted before its corresponding entry is inserted into ConnDec. This can happen if flow2 and flow1 arrive at the programmable network device 104 within a very short time (i.e., RTT) and have the same hash key h. To address this issue, the network security system 100A can recirculate the remaining packets of flow1 for a time exceeding the expected RTT to ensure that flow1's entry is inserted into ConnDec.

It should be noted that such recirculation rarely happens however as flow2 and flow1 need to (1) have a collision, and (2) arrive at the switch within RTT (typically in milliseconds). Otherwise, flow1's entry is already inserted into ConnDec, and thus, the remaining packets of flow1 can bypass the buffer checking, and its entry in the buffer can be safely evicted. An example implementation uses a buffer with up to 232 entries, utilizing the output of CRC-32 hash function as the key. Tofino™2 hardware has more resources and can accommodate a buffer with up to 264 entries, further reducing the chance of collisions.

The network security system 100A can mitigate flood attacks. Although the network defense of the network security system 100A can effectively shield against cross-host attacks, mitigating the potential risk of exploitation posed by malicious hosts may be needed. For example, an attacker can exhaust the stateful storage of the ConnDec table by initiating many new connections. To counter this, the network security system 100A employs a rate-limiting strategy that restricts the number of requests from an IP address over a certain period. The network security system 100A also periodically removes inactive connections from ConnDec to avoid resource exhaustion.

The network security system 100A can realize decentralized privilege capabilities. It should be noted that the network security system 100A does not focus on regulating communications within hosts in some implementations. For intra-host communications, the network security system 100A may use eBPF programs to implicitly propagate labels by adding tags to the relevant BPF maps to satisfy safe message rules according to example implementations. These implementations can allow information to flow freely within a host according to the subject's choice.

For inter-host communications, the network security system 100A can support information declassification (or endorsement) controls by removing (or adding) tags in packets. In existing OS-level DIFC systems, processes on hosts are responsible for declassifying or endorsing tags. However, this approach can potentially overwhelm the hosts, especially for high-traffic networks, where the CPU can become a performance bottleneck when handling high-volume requests. Therefore, the network security system 100A can offload the tag capabilities to the programmable network device 104 according to the defined NETCL policies. For a network flow that passes through the programmable network device 104, the programmable network device 104 modifies the labeled packet header on the fly by removing secrecy tags (for declassification) or adding integrity tags (for endorsement).

The programmable network device 104 may need to modify multiple tags at once. For example, when a process exports data to the external world, the label for the network flow, potentially containing several tags, may need to be downgraded to an empty label {}. To efficiently realize this feature, the network security system 100A can use bitmasks. For example, when an in-network policy is hit, the programmable network device 104 receives a bitmask mask indicating which tags to modify (bit set to 1). For declassification, the programmable network device 104 performs a bitwise AND operation between the DIFC packet header and ~mask to clear secrecy tags. For endorsement, the programmable network device 104 performs a bitwise OR operation with mask to add integrity tags.

NETCL policies defined by the network administrator 212 are compiled into different in-network policies to be executed in the programmable network device 104. For example, one type of in-network policy performs DIFC label pattern matching, which matches the network flow by examining the specific DIFC tags contained in the flow's DIFC packet header. Other types of policies include matching by the flow's source and destination hosts and matching by the TrackerID tag. To store these in-network policies in the programmable network device 104, a naive way may be to use a single large match/action table, similar to the traditional firewall structure. However, this design is highly inefficient as the policies that perform DIFC label pattern matching may require ternary matching, which is expensive for DIFC packet headers of 32 bytes and may need to be placed in TCAM. Since TCAM has a much smaller capacity than SRAM, placing all policies in a single table in TCAM would quickly exhaust the capacity thereof, resulting in only a few hundred policies that can be stored.

To store these policies efficiently within limited switch memory, the programmable network device 104 can employ a multi-table flow matching technique. For example, in-network policies can be placed in multiple match/action tables in different types of memories based on the type of matching. While policies that need DIFC label pattern matching can be placed in TCAM, the other policy types that need exact matching can be placed in the match/action tables in SRAM. Compared to single-table designs, this implementation with multi-table flow matching techniques increased the policy storage capacity by 12 times according to an example implementation, although this number may vary based on other implementations and change of parameters.

The network security system 100A can implement priority-based enforcement of security policies. Similar to some firewall policy designs, the network administrator 212 can define the priority of NETCL policies, and the network security system 100A can maintain the priority of each policy in a table entry. For example, in FIG. 4, the drop policy (order 1) has a higher priority than the allow policy (order 2). If a network flow matches multiple entries across different match/action tables, the programmable network device 104 may execute the one with the highest priority. If no policy matches, the network flow may be dropped by default.

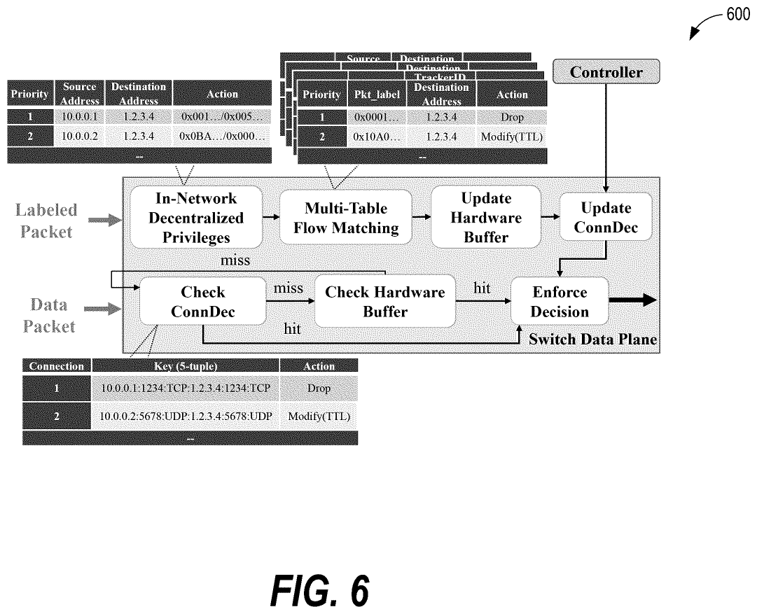

FIG. 6 depicts an in-network packet processing workflow 600 implementable in the network security systems 100 and 100A according to various embodiments. In the packet processing workflow 600, labeled packets (which carry a DIFC packet header) undergo initial matching against declassification/endorsement policies for tag modifications, followed by matching against in-network policies for security decisions. The decision is then stored in the hardware buffer and the ConnDec table in the data plane. Subsequent packets in the network flow (which do not carry a DIFC packet header) are processed against the pre-determined decision stored in the data plane, ensuring quick handling of subsequent packets.

The host agents 108 can include eBPF-based host agents. The host agents 108 can persist DIFC context both within the host and from/to the network with minimal overhead. Enabled by eBPF, the host agents 108 are lightweight and readily deployable without any kernel modifications in contrast to some works which require extensive kernel modifications to track intra-host information flows. EBPF is an emerging kernel technology that enables sand-boxed programs to run in the kernel space without modifying the kernel source code or loading additional modules. EBPF can enhance the performance, security, and flexibility of the kernel by allowing dynamic and event-driven programming.

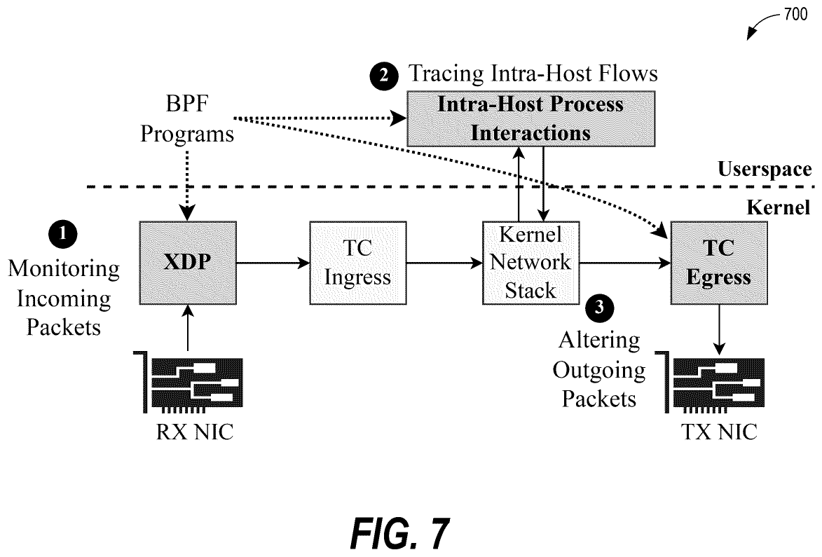

FIG. 7 depicts eBPF hooks and intra-host label propagation paths 700 implementable in the network security systems 100 and 100A according to various embodiments. The host agents 108 can maintain lightweight label persistence by attaching defined eBPF hooks in the kernel to capture the complete chain of intra-host events and can accurately propagate DIFC labels. The host agents 108 are compatible with a wide range of kernel versions, facilitating deployment in large, heterogeneous networks with various system configurations, and these eBPF hook points are shown in FIG. 7. Multiple BPF maps can be implemented to share data between these eBPF programs.

For monitoring incoming packets, the first hook monitors incoming labeled packets and extracts DIFC labels. To achieve high-performance packet processing, XDP (eXpress Data Path) technology can be leveraged to directly attach the eBPF program to the network device. When a new packet arrives, a callback can invoke the eBPF program. If the “evil bit” of the packet is set, the eBPF program can extract the label information and store the destination port in a BPF map inLabels (dport->[Label, TrackerID]). Then, the eBPF program can remove the DIFC packet header and reset the “evil bit”, restoring the original form for further kernel network stack processing. To identify which process receives the labeled packet, the eBPF program monitors processes that invoke a system call to receive a network connection. When a process accepts a connection, the eBPF program looks up the destination port in inLabels. If there is a match, the eBPF program can extract the label information and the process ID (PID) of the receiving process and store the information in another BPF map, pidLabels (PID->[Label, TrackerID]).

For tracing intra-host flows, the second hook can track the propagation of DIFC labels between processes and files during intra-host activities through a data provenance mechanism. This captures the chain of activities from the process that initially receives the labeled network flow to the process responsible for sending out network traffic. The eBPF program monitors system calls related to process creation, and can extract the PID and the parent PID of the newly created process. Using the parent PID as a lookup key, the eBPF program retrieves the associated label from pidLabels and propagates it to the child PID and updates pidLabels. If a process is terminated, the eBPF program will remove the entry from pidLabels, ensuring that the same PID can be reused.

For file operations, the eBPF program maintains a BPF map, fileLabels (Inode->[Label, TrackerID]), that associates file inodes with their respective labels. When a new file is created, the file is assigned the same label as the creating process, and fileLabels is updated. This ensures that the file inherits the appropriate label and aligns with the security context of the creating process. During a file read, the eBPF program retrieves the file's label from fileLabels and uses it to update the label of the process (by updating pidLabels) that performs the read operation. When a file is deleted, the eBPF program removes the entry from fileLabels so that the inode can be reused. Tracking file activities helps identify attackers who may save stolen information in files and exfiltrate it later.

For altering outgoing packets, the third hook ca modify the outgoing packets by incorporating the propagated DIFC labels. When a process invokes a system call to send a network message, the eBPF program is triggered to search for the PID in pidLabels. Once the sending process is identified, the process's label and the source port are stored in a new BPF map, outLabels (sport->[Label, TrackerID]). To match outgoing packets, the eBPF program is loaded into the TC (traffic control) Egress. When a packet exits, the eBPF program checks whether the packet's source port has been marked in outLabels. If a match is found, the eBPF program can prepare the corresponding DIFC label in a DIFC packet header and insert the header into the outgoing packet.

As BPF maps reside in the kernel space, BPF maps may not be persistent across eBPF programs reloading or system reboots. This can cause problems when the attacker performs file activities. Though the file data persists in the filesystem, the BPF maps can be lost, resulting in inaccurate label propagation. To keep BPF maps persistent across eBPF programs reloading, the host agents 108 can mount the eBPF virtual filesystem to the kernel memory, allowing the eBPF programs to pin their maps to the eBPF virtual filesystem by creating a file descriptor that points to these BPF maps. This file descriptor is linked to a specific pathname in the eBPF filesystem. As a result, the kernel will retain the BPF maps even if the referencing eBPF program is unloaded, as the corresponding file descriptor will keep pointing to the BPF maps.

To further persist BPF maps across system reboots, the host agents 108 can migrate the BPF maps to a permanent filesystem on the host machine. When the host agent (e.g., the host agents 108a or 108b) detects the kernel_restart or kernel_power_off system events, the host agent can immediately migrate the BPF maps to a backup file in the permanent filesystem before the system reboots. After the system reboots, the host agent can repopulate the BPF maps with the entries from the backup file. This repopulation may occur only once before the host agent resumes its functions upon reboot. The host agent can also migrate BPF maps in case of a system crash, by detecting abnormal terminations of critical processes using the process_exit hooks.

The network security system 100A can leverage the distributed nature of networks to optimize the deployment of in-network policies in the programmable network device 104. A naive approach may install identical policies on every switch, which wastes space on switches that would never match those policies. In contrast, the network security system 100A can place policies only on programmable network devices (e.g., programmable switches) that are likely to see the matching traffic. For example, each policy can be placed in a programmable network device that is directly connected to the destination address defined in the policy, similar to the setup of distributed firewalls. Once a flow is matched and is allowed to pass, remaining programmable network devices may need to forward its packets, ensuring strict security and consistency of policy enforcement. A destination address was selected instead of the source address because otherwise, an attacker could bypass the policies by using different hosts. With this design, storage overhead can be significantly reduced and unnecessary latency can be minimized from re-matching the same flow.

The network security system 100A provides seamless integration into the existing network infrastructure that uses programmable switches, eliminating the need for installing additional middleboxes while offering minimal disruption to the network performance. The central management of these switches by the control plane ensures up-to-date policy installation and simplifies maintenance. Coordinating a distributed defense as a single entity in large infrastructures is complex. Network segmentation can address this challenge by dividing the network into distinct segments, each governed by its specific set of policies. The network security system 100A can function to configure switches within each segment to manage their respective DIFC tags and policies. This configuration provides fine-grained control over individual segments, enhancing defense capabilities by accommodating a large number of DIFC tags in the network.

The network security system 100A provides an expressive DIFC policy language, referred to herein as NETCL for specifying diverse DIFC policies to counter different attack scenarios. These policies are enforced in priority order and can be dynamically updated at runtime. Despite multiple domain-specific languages proposed for network management and network security, none are designed for network-level DIFC policies.

An example syntax of NETCL is provided below:

Primitive Actions
A::=label_host(ip, label) |label_file(ip, file_path) |drop |allow |reroute(port) |modify(header) |alert |declassify(tags) |endorse(tags)

Expressions
E::=header_field |var

Predicates
P::=match(P && P) |E op E |!P

Policies
C::=A |if P then C |(C |C)

Operations
op∈{==, >=, <=, Contains}
NetCL can provide two labeling functions to initialize DIFC labels: label_host(ip, label) assigns a label to a specific host's IP address, initializing all existing processes and files with the host's label; label_file(host_ip, file_path) assigns a unique TrackerID to a file on a host for fine-grained tracking of sensitive files. These functions can be used during initial deployment or subsequent stages when new hosts or files need labeling.

A NETCL policy is comprised of a flow-matching predicate and an action. Various patterns are provided to match a network flow based on the source and final destination hosts on a cross-host path, the DIFC tags, and others. Expressions (E) can represent constants (var) such as IP addresses and DIFC tags, as well as DIFC or IP packet header fields (header_field) such as dst_ip and pkt_label. TrackerID can be represented by the location of the tagged file (i.e., file_path@host_ip). Predicates (P) are built over expressions with comparison operations (E op E), which are used to match network flows and trigger actions. The keyword contains checks a subset of DIFC tags in the DIFC packet header of a network flow.

NETCL provides multiple primitive security actions. A drop action can discard a flow at the programmable network device 104. An allow action can forward a flow based on the configured forwarding table. A reroute(port) action ca redirect suspicious traffic to a predefined destination, such as a logging server or a deep packet inspection (DPI) system, for further scrutiny or processing. A modify(header) action can use the programmable parser of the switch to modify the packet header. For instance, the network security system 100A can reset specific packet headers (e.g., IP options and TTL) which may be used as a covert channel for data exfiltration. An alert action can serve as a detection mechanism, generating alerts to notify the network administrator when a suspicious flow is detected.

NETCL can also provide privileged actions. The declassify(tags) action removes specified tags, allowing sensitive data declassification. The endorse(tags) action adds designated tags, endorsing the flow's integrity. Additionally, the endorsement action allows inserting tags for flows originating from external addresses, where no host agent is installed. These actions enable the programmable network device 104 to regulate information flows from external addresses within the network.

To enforce user-defined NETCL policies in the data plane, the network security system 100A can employ an efficient compiler to compile and execute NETCL policies in the programmable network device 104. The label initialization statements are interpreted, and the programmable network device 104 uses a hardware packet generator to send a control packet containing the DIFC label to the respective host agent. For NETCL matching policies, developing an efficient compilation strategy can be important to counter the rapidly changing behaviors of attackers. When the attacker changes the strategies, the matching patterns may need to be updated accordingly, and the updated policy must be quickly recompiled and pushed to the programmable network device 104. A naive compilation strategy may compile a NETCL policy into a P4 program to run in a programable switch. However, this approach would require reloading the P4 program every time a policy changes, which would interrupt the network traffic and cause significant disruption.

To improve defense agility, the network security system 100A can employ an efficient compilation mechanism that supports dynamic update of NETCL policies without interrupting traffic. NETCL policies can be compiled into corresponding switch configurations pertaining to the programmable network device 104, which are a set of parameters that may define a switch's operations, including match-action table entries for packet header matching, associated actions, and policy priority levels. These switch configurations then insert in-network policies into respective match/action tables within a switch. A P4 program may need to be implemented to specify the logic to parse customized packet headers and define match/action tables. However, this P4 program does not contain specific match/action rules, and may need to be compiled by the P4 compiler (different from the NETCL compiler) and loaded into a switch only once. After the compilation, the switch configurations are passed to the switch daemon in the control plane. Whenever the NETCL policies change, the NETCL compiler can generate new switch configurations, and the switch daemon can update the match/action tables by adding or removing in-network policies accordingly. This mechanism allows the control plane to seamlessly add or remove in-network policies.

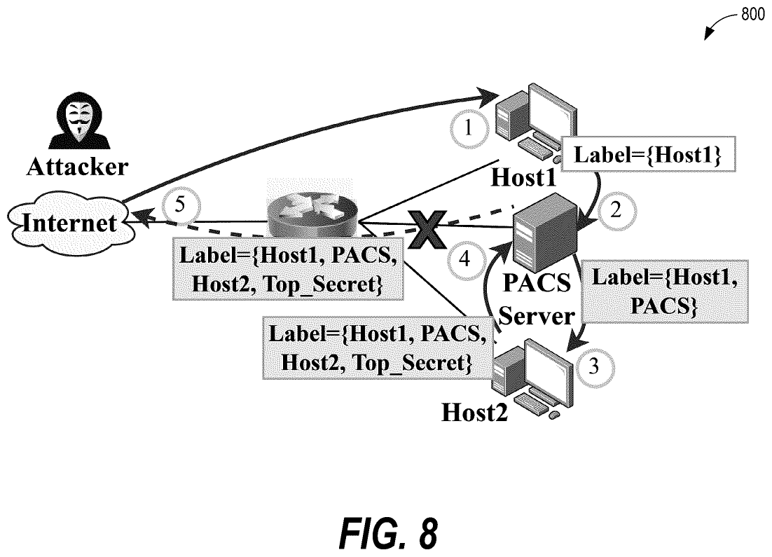

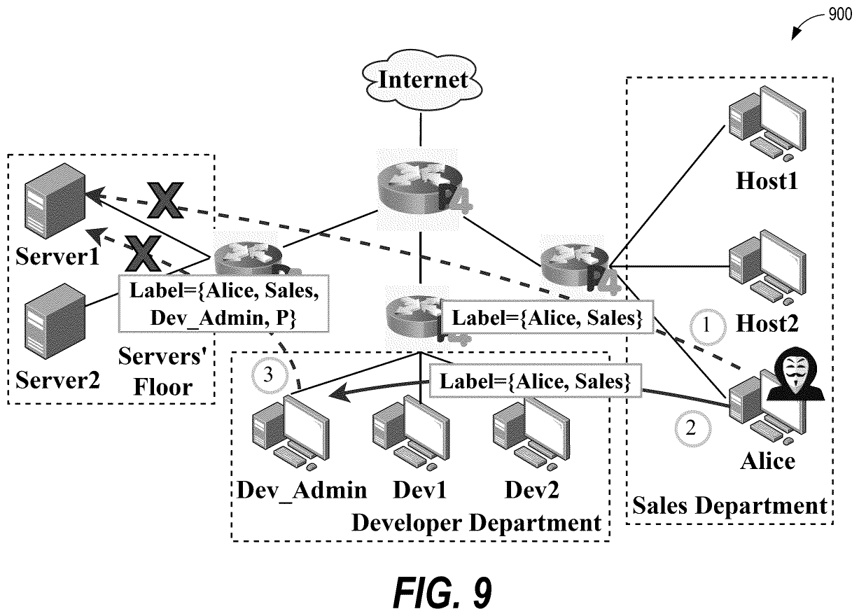

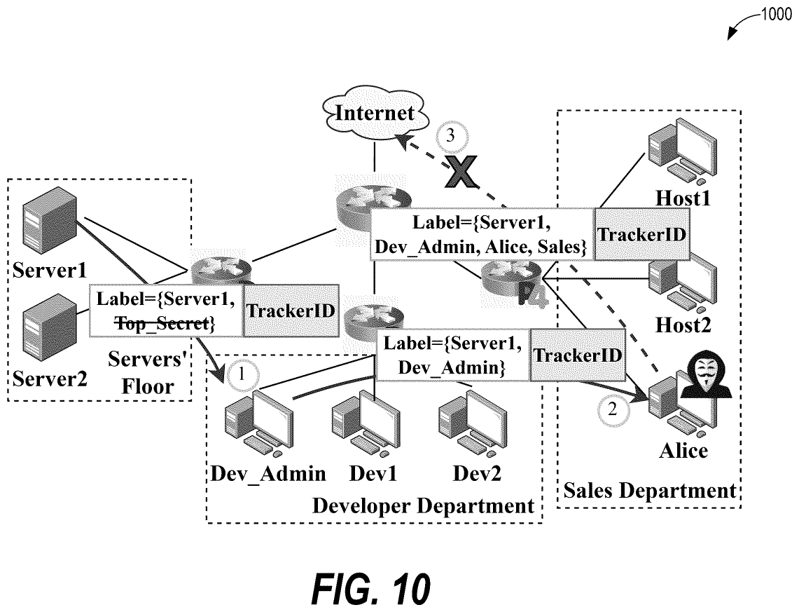

FIG. 8 depicts an example host system 800 incorporating a defense workflow for preventing data exfiltration, FIG. 9 depicts an example host system 900 incorporating a defense workflow for preventing unauthorized access while endorsing high-integrity users for access, and FIG. 10 depicts an example host system 1000 incorporating a defense workflow for fine-grained tracking of sensitive information, according to various embodiments. The host system 800 is representative of a real-world data leakage incident against a hospital network. An attacker first compromises Host1's web browser to get into the internal network, aiming to exfiltrate sensitive data from Host2. The network has a picture archiving and communication system (PACS) server that is less secure and allows widespread data sharing. The firewall blocks direct connections from Host1 to Host2 and from Host2 to the external network. To bypass the firewall, the attacker uses the PACS server as a stepping stone to reach Host2 and then moves the data from Host2 to PACS and ultimately to the external network.

Listing 1 below shows example NETCL policies for preventing exfiltration of top-secret data:
1 #Initialize labels
2 label_host(ip=Host1, label={Host1})
3 label_host(ip=Host2, label={Host2, Top_Secret})
4 label_host(ip=PACS, label={PACS})
6 #Drop network flows containing Top_Secret data
7 if match(pkt_label contains Top_Secret && dst_ip==external_network) then drop
9 #Allow traffic between hosts and PACS server
10 if match(src_ip==Host1 && dst_ip==PACS) then allow
11 if match(src_ip==PACS && dst_ip==Host2) then allow
12 if match(src_ip==Host2 && dst_ip==PACS) then allow
14 . . . #Other policies that allow benign traffic
15 #Drop All (default Deny)
Listing 1: Preventing exfiltration of top-secret data

Additional policies that allow benign traffic are omitted. Network flows that do not match any policies are dropped by default. Using DIFC labels and a matching policy, Host2's data can be protected with the Top_Secret tag from being leaked, regardless of intermediate hosts. For example, when the attacker attempts to export the secret data from PACS to the external network, the network security system 100A can detect the presence of the Top_Secret tag in the network flow and block the flow (Line 7).

The host system 900 is representative of an enterprise network where each department is protected by a firewall. Only Alice can access both the sales and developer resources, and only Dev_Admin has permission to access the Servers' Floor. Alice, as an insider attacker, can abuse her permissions and use a zero-day vulnerability to compromise Dev_Admin to gain further access to the Servers' Floor.

Listing 2 shows example NETCL policies for endorsing users to access protected resources:
1 #Initialize labels
2 label_host(ip=Sales_Dept, label={Sales})
3 label_host(ip=Alice, label={Alice, Sales})
4 label_host(ip=Dev_Admin, label={Dev_Admin})
6 #Endorse network flows (add tag) from Dev_Admin
7 if match(src_ip==Dev_Admin && dst_ip==Servers_Floor) then endorse({P})
9 #Only allow network flows with the integrity tag P
10 if match(src_ip==Sales_Dept && dst_ip==Servers_Floor) then drop
11 if match(pkt_label contains P && dst_ip==Servers_Floor) then allow
13 . . . #Other policies that allow benign traffic
14 #Drop All (default Deny)
Listing 2: Endorsing Users to Access Protected Resources

Listing 2 shows how the network security system 100A can prevent unauthorized insiders from accessing the Servers'Floor while only endorsing Dev_Admin for access. For example, only the Dev_Admin can be allowed to access the servers, by adding the tag P to flows originating from Dev_Admin (Line 7) and checking the presence of the tag P (Line 11). Even if Alice exploits a vulnerability in Dev_Admin (2) to acquire the needed tag, the policy at Line 10 will detect the Sales tag in the network flow and block Alice from connecting to the servers (3).

The host system 1000 is representative of a situation where fine-grained tracking may be needed to further restrict the propagation of declassified files. A protected file on Server1 is declassified to Dev_Admin for sharing within the company's internal network. However, Alice may profit from gaining early access to confidential information and leaking the file to the external network without the permission of the company.

Listing 3 shows example NETCL policies for preventing exfiltration of declassified information:
1 #Initialize labels and TrackerID for the sensitive file
2 label_file(ip=Server1, file=/server1/sensitive_file)
3 label_host(ip=Server1, label={Server1, Top_Secret})
4 label_host(ip=Dev_Admin, label={Dev_Admin})
5 label_host(ip=Alice, label={Alice, Sales})
7 #Declassify Top_Secret (remove tag) data to Dev_Admin
8 if match(src_ip==Server1 && dst_ip==Dev_Admin) then declassify({Top_Secret})
10 #Prevent the tainted file from leaving the network
11 if match(tracker_id==/server1/sensitive_file@Server1 && dst_ip==external_network) then drop
13 #Prevent Top_Secret data from leaving Server1
14 if match(pkt_label contains Top_Secret && dst_ip==any) then drop
16 . . . #Other policies that allow benign traffic
17 #DROP ALL (default deny)
Listing 3: Preventing exfiltration of declassified information

Listing 3 shows how the network security system 100A can track propagation of sensitive information and prevent the information from being leaked to the external network. The network security system 100A assigns a unique TrackerID tag to the sensitive file being tracked (Line 2). Top_Secret files are protected and cannot leave Server1 without explicit declassification (Line 14). When the network security system 100A declassifies this file for Dev_Admin, the network security system 100A removes the Top_Secret tag (Line 8) but retains the TrackerID with the network flow (1). After Alice acquires a copy of the file (2) and attempts to leak it, the TrackerID persists with her outgoing network flow (3), enabling the network security system 100A to block the flow (Line 11).

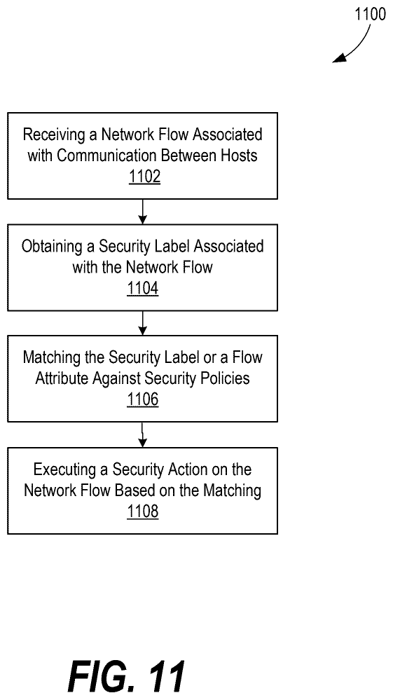

FIG. 11 depicts an example method 1100 for cross-host attack prevention according to various embodiments. The method 1100 can be implemented by the network security system 100 or 100A. In example implementations, one or more steps of the method 1100 can be performed by the programmable network device 104. In other implementations, one or more steps of the method 110 may be performed by the programmable network device 104 in combination with the policy controller 102 or the host agents 108. At step 1102, the programmable network device 104 can be configured to receive a network flow associated with communication between a plurality of hosts. The programmable network device 104 can receive packets that are parsed by a parser engine, and flow attributes can be extracted (e.g., packet header field, a 5-tuple, a source or destination internet protocol (IP) address, a port number, connection metadata, routing or topology attributes, or security context attributes, etc.).

At step 1104, the programmable network device 104 can be configured to obtain a security label associated with the network flow received at step 1102. The security label may be embedded in a packet header (e.g., DIFC header), carried as metadata from ingress, or the security label may be looked up from a state table based on flow ID. The programmable network device 104 can parse a label field of a packet to extract the security label.

Obtaining the security label can include propagating the security label among each of the plurality of hosts associated with a cross-host propagation history. For example, the network flow may be associated with the cross-host propagation history of each host that an attacker has traversed through. A host agent (e.g., host agent 108a) can be configured to propagate the security label within a host (e.g., host 106a) and attach the label to outbound flows in some embodiments. For example, within a single host, if a process reads a file, the process may inherit a security tag. When the process sends data, an outbound flow may inherit the tag via a host agent. For a labeled flow to travel from one host to another host, the labeled flow also traverses through a programmable network device, such as a programmable switch. In this way, the programmable network device 104 can carry the label across various hosts that an attacker traverses through, and the security tags that make up the security label can persist through each host the attacker traverses through. The programmable network device 104 can enforce and may modify labels according to some examples. One or more security tags can be encoded in the security label, and each of the one or more accumulated security tags can correspond to one or more of a host category, a secrecy tag, or an integrity tag.

At step 1106, the programmable network device 104 can be configured to match the security label obtained in step 1104 or the flow attribute extracted in step 1102 against a plurality of security policies. The plurality of security policies may be specified by a network administrator (e.g., the network administrator 212), and the policy controller 102 can be configured to compile high-level security policies (e.g., NETCL policies) and install match entries into switch tables and determine rule priorities of the security policies. The programmable network device 104 can match the security label or the flow attribute to the security policies via a match/action pipeline by matching the security label or flow attribute against the security policies in a prioritized order. In some examples, the compiled security policies may be stored in a plurality of match/action tables in different memories of the programmable network device 104. In some embodiments, the different memories can include SRAM and TRAM, and policies that need DIFC label pattern matching can be placed in TCAM, while other policy types that need exact matching can be placed in match/action tables in SRAM.

At step 1108, the programmable network device 104 can be configured to execute a security action on the network flow received at step 1102, by either dropping packets, forwarding the network flow, modifying security labels, adding/removing tags, rerouting, rate-limiting, or triggering alert metadata. Examples of security actions that are implemented by the programmable network device 104 for cross-host attack prevention are shown with respect to FIGS. 4 and 8-10.

In an example embodiment, the plurality of hosts described in step 1102 includes at least a first host 106a and a second host 106b, with the second host 106b being a destination host. The security label obtained in step 1104 by the programmable network device 104 includes an in-network security policy that specifies a match condition relating to the security tag attributable to the first host 106a. The security action executed in step 1108 by the programmable network device 104 includes dropping or blocking forwarding of the network flow to the destination host 106b.

Various embodiments directed to network security systems (e.g., the network security systems 100 and 100A) have been described for preventing cross-host attacks in real time. The network security systems 100 and 100A employ in-network DIFC mechanisms based on programmable network devices and eBPF, and offer expressive policy frameworks for specifying DIFC policies. The network security systems 100 and 100A are effective against various cross-host attacks while maintaining line-rate performance with minimal overhead.

The concepts described herein can be combined in one or more embodiments in any suitable manner, and the features discussed in the embodiments are interchangeable in some cases. Example embodiments are described herein, although a person of skill in the art will appreciate that the technical solutions and concepts can be practiced in some cases without all of the specific details of each example. Additionally, substitute or equivalent steps, components, materials, and the like may be employed.

The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Terms such as “a,” “an,” “the,” and “said” are used to indicate the presence of one or more elements and components. The terms “comprise,” “include,” “have,” “contain,” and their variants are used to be open ended and may include or encompass additional elements, components, etc., in addition to the listed elements, components, etc., unless otherwise specified. The terms “first,” “second,” etc. may be used as differentiating identifiers of individual or respective components among a group thereof, rather than as a descriptor of a number of the components, unless clearly indicated otherwise.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The flowchart of FIG. 11 is the functionality and operation of one or more components of the network security system 100 or 100A. For example, the steps of the method 1100 can correspond to implementation of processor-readable instructions executed by processing circuitry or at least one processor (e.g., hardware processor, software processor, or a combination of both) of the programmable network device 104. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowchart of FIG. 11 shows a specific order of execution, it is understood that the order of execution may differ from that which is depicted. For example, the order of execution of two or more blocks may be scrambled relative to the order shown. Also, two or more blocks shown in succession in FIG. 11 may be executed concurrently or with partial concurrence. Further, in some embodiments, one or more of the blocks shown in FIG. 11 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Although embodiments have been described herein in detail, the descriptions are by way of example. The features of the embodiments described herein are representative and, in alternative embodiments, certain features and elements can be added or omitted. Additionally, modifications to aspects of the embodiments described herein can be made by those skilled in the art without departing from the spirit and scope of the present invention defined in the following claims, the scope of which are to be accorded the broadest interpretation so as to encompass modifications and equivalent structures.

Therefore, at least the following is claimed:

1. A network security system, comprising:
one or more memories storing processor-readable instructions; and
one or more processors configured to access the one or more memories and execute the processor-readable instructions to perform operations, the operations comprising:
receiving a network flow associated with communication between a plurality of hosts;
obtaining a security label associated with the network flow;
matching the security label or a flow attribute of the network flow against a plurality of security policies; and
executing a security action on the network flow based on the matching to restrict unauthorized inter-host information flow among the plurality of hosts.

2. The network security system of claim 1, wherein the flow attribute comprises one or more of a packet header field, a 5-tuple, a source or destination internet protocol (IP) address, a port number, connection metadata, routing or topology attributes, or security context attributes.

3. The network security system of claim 1, wherein obtaining the security label comprises propagating the security label among each of the plurality of hosts associated with a cross-host propagation history, the cross-host propagation history being associated with the network flow.

4. The network security system of claim 3, wherein the security label comprises one or more accumulated security tags associated with each of the plurality of hosts associated with the cross-host propagation history.

5. The network security system of claim 4, wherein the one or more accumulated security tags are encoded in the security label, each of the one or more accumulated security tags corresponding to one or more of a host category, a secrecy tag, or an integrity tag.

6. The network security system of claim 1, wherein the plurality of security policies comprise a compilation of in-network policies that specify match conditions and corresponding security-action rules.

7. The network security system of claim 1, wherein the security label comprises a decentralized information flow control (DIFC) label associated with a DIFC mechanism.

8. The network security system of claim 1, wherein the security action comprises dropping or blocking the network flow, blocking establishment of a new network flow from an originating host, or preventing lateral movement attempts of the originating host.

9. The network security system of claim 1, wherein executing the security action comprises modifying the security label for declassification or endorsement of the network flow.

10. The network security system of claim 1, wherein:
the plurality of hosts comprise a first host and a second host with the second host being a destination host, and the security label comprises a security tag attributable to the first host;
the plurality of security policies comprise an in-network security policy that specifies a match condition relating to the security tag attributable to the first host; and
the security action comprises dropping or blocking forwarding of the network flow to the destination host.

11. The network security system of claim 1, wherein matching the security label or the flow attribute of the network flow against the plurality of security policies comprises matching the security label or the flow attribute against the plurality of security policies in a prioritized order.

12. The network security system of claim 1, wherein the one or more memories and the one or more processors are associated with one or more programmable network devices.

13. The network security system of claim 12, wherein the one or more programmable network devices comprise one or more programmable switches or one or more smart network interface cards (NICs).

14. The network security system of claim 1, wherein the one or more memories comprise a first memory and a second memory, and the plurality of security policies are stored in a plurality of match/action tables in the first memory and the second memory.

15. The network security system of claim 14, wherein the first memory comprises static random access memory (SRAM) and the second memories comprises ternary content addressable memory (TRAM).

16. A computer-implemented method, comprising:
receiving, by a programmable network device, a network flow associated with communication between a plurality of hosts;
obtaining, by the programmable network device, a security label associated with the network flow;
matching, by the programmable network device, the security label or a flow attribute of the network flow against a plurality of security policies; and
executing, by the programmable network device, a security action on the network flow based on the matching to restrict unauthorized inter-host information flow among the plurality of hosts.

17. The computer-implemented method of claim 16, wherein obtaining the security label comprises propagating the security label among each of the plurality of hosts associated with a cross-host propagation history, the cross-host propagation history being associated with the network flow.

18. The computer-implemented method of claim 17, wherein the security label comprises one or more accumulated security tags associated with each of the plurality of hosts associated with the cross-host propagation history.

19. The computer-implemented method of claim 16, wherein the plurality of security policies comprise a compilation of in-network policies that specify match conditions and corresponding security-action rules.

20. The computer-implemented method of claim 16, wherein matching the security label or the flow attribute of the network flow against the plurality of security policies comprises matching the security label or the flow attribute against the plurality of security policies in a prioritized order.
